(19) United States
(12) Patent Application Publication
(10) Pub. No.: US 2004/0081027 A1
(43) Pub. Date: Apr. 29, 2004

(54) Timepiece including analogue time display means, associated with day-night or AM-PM indicating means

(75) Inventor: Beat Gilomen, Grenchen (CH)

Correspondence Address: SUGHRUE MION, PLLC, 2100 PENNSYLVANIA AVENUE, N.W., SUITE 800, WASHINGTON, DC, 20037, US

(73) Assignee: ETA SA MANUFACTURE HORLOGERE SUISSE

(21) Appl. No.: 10/689,040

(22) Filed: Oct. 21, 2003

(30) Foreign Application Priority Data
Oct. 22, 2002 (CH) 1767/02

(51) Int. Cl. G04B 19/00; G04C 21/00; G04B 19/04; G04B 19/06

(52) U.S. Cl. 368/76; 368/80

(57) ABSTRACT

Timepiece including an analogue display (12, 36) arranged such that the hour hand completes one revolution in twelve hours. This analogue display is associated with a coaxial disc (10) driven so as to complete one revolution in twenty-four hours in the same direction as the hour hand. The visible surface (14) of the disc visually defines two half-discs arranged to indicate AM-PM or day-night information relating to the displayed time.

The present invention concerns a timepiece including an analogue time display arranged such that the hour hand completes one revolution in twelve hours. In particular, the present invention concerns the display of a second time zone different from the time zone in which the user of the timepiece is located.

The display of a second time zone using a hand completing one revolution in twelve hours raises the known problem of AM-PM or day-night determination of the displayed time.

One solution to this problem consists in providing this second time zone time display by an hour hand completing one revolution in twenty-four hours. However, within the scope of the present invention, one wishes to display the local time in the second time zone in a conventional manner, i.e. using a hand completing one revolution in twelve hours.

Thus, it is an object of the present invention to provide indication of the local time in a second time zone using an hour hand completing one revolution in twelve hours and associated with means for indicating AM-PM or day-night information that is very easy for the user to read.

Another object of the invention is to provide such a display using a relatively simple and inexpensive mechanism.

The timepiece according to the invention thus includes a disc having a visible surface and defining a geometrical rotational axis which is identical to the axis of the hour hand, this disc being driven by drive means so as to complete one revolution in twenty-four hours in the same direction as said hour hand. The visible surface of said disc visually defines two half-discs positioned, relative to said hour hand, to indicate AM-PM or day-night information relating to the time displayed by this hour hand.

Owing to the features of the invention, reading AM-PM or day-night information is direct and user-friendly. Indeed, this information is directly associated with the hour hand and provided by the relative position between said hand and the coaxial disc.

The present invention will be described more precisely hereinafter using the following description, made with reference to the annexed drawings, given by way of non-limiting examples, in which:

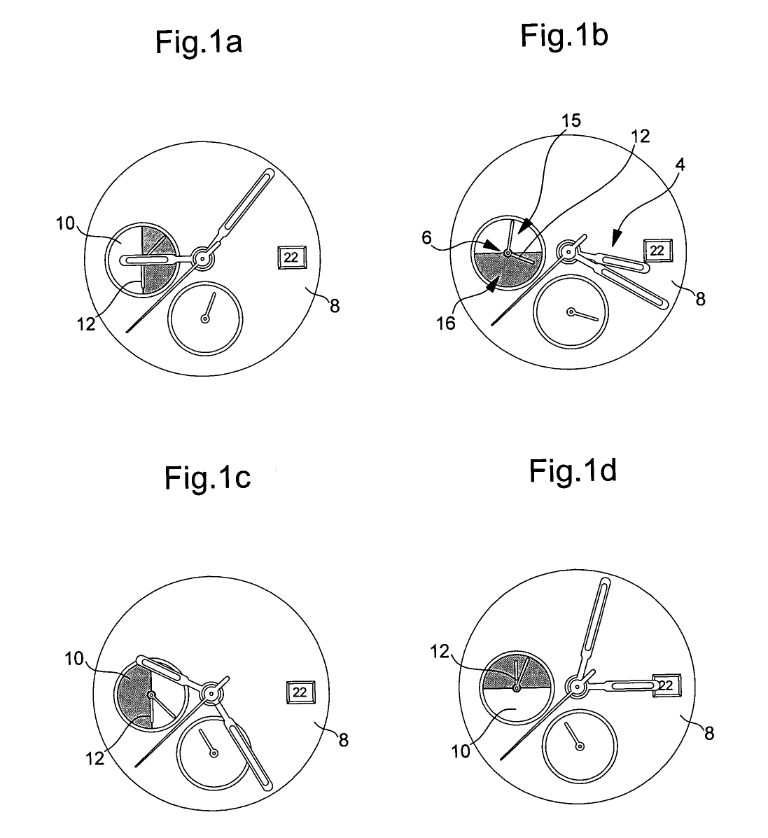

FIG. 1 shows a timepiece according to the invention with indication of the local time in a second time zone at four different moments (FIGS. 1a, 1b, 1c and 1d) in one day, and

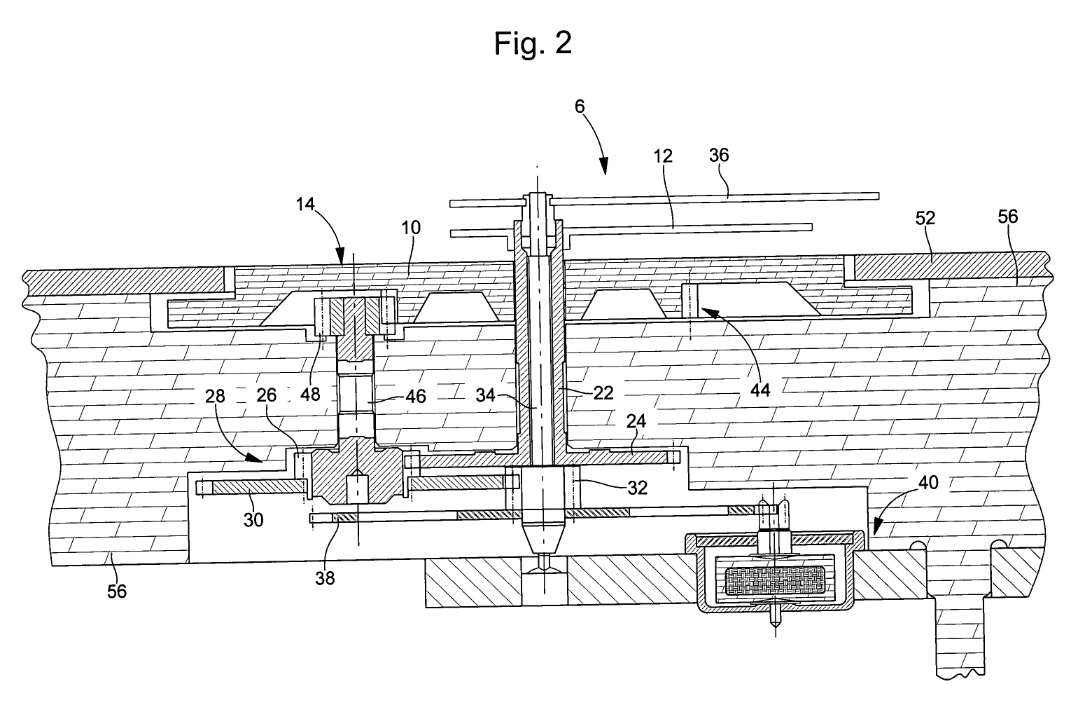

FIG. 2 shows schematically in cross-section an embodiment of the timepiece according to the invention.

FIG. 1 shows a timepiece according to the invention at four different moments in a day respectively in FIGS. 1a) to 1d). The timepiece has an analogue display of two different time zones. The time in the first zone is displayed by a set of central hands 4. The time in the second time zone is displayed by a set of hands 6 that are off-centre with respect to the central axis of dial 8. The present invention concerns second display 6 generally used for displaying the time in a second time zone different to that in which the user of the timepiece is located.

Second set of hands 6 is driven such that the hour hand completes one revolution in twelve hours, in a similar way to the first set of hands. Under the second set of hands there is provided a disc 10 whose geometrical axis of rotation is identical to the axis of hour hand 12 of the second set. This disc 10 is driven by drive means, particularly like those shown in FIG. 2, so as to complete one revolution in twenty-four hours in the same direction as hand 12. Moreover, visible surface 14 visually defines two half-discs 15 and 16 used to indicate whether the time displayed is in the ante-meridian (AM) or in the post-meridian (PM) period, in a variant that is not shown here, or whether the displayed time corresponds to the daytime period (day) or night period (night), as is the case in the variant shown in FIG. 1. Disc 10 is positioned relative to hour hand 12 such that the position of said hand relative to the disc directly indicates the period in which the displayed time is located. More precisely, the information is given by superposing hour hand 12 with one of the two half-discs 15 and 16. It will be noted here that other graphic diagrams for visually delimiting two half-discs can be envisaged.

Thus, in FIG. 1a), the time indicated corresponds to sunrise, i.e. six o'clock in the morning in the second time zone in question. FIG. 1b) corresponds to midday approximately, whereas FIG. 1c) substantially corresponds to sunset, i.e. approximately six o'clock in the evening. Finally, FIG. 1d) corresponds to midnight in the second time zone. As appears from the description hereinbefore, it is direct and easy for a reader to read the period corresponding to the time displayed by second set of hands 6.

FIG. 2 shows schematically in cross-section a particular embodiment of the drive means for disc 10 according to the invention. This disc is pierced at its centre and is freely mounted about hour pipe 22 of hour hand 12. Hour pipe 22 ends in a wheel 24 which meshes with pinion 26 of Minute wheel set 28. Minute wheel set 28 also includes a wheel 30 which meshes with a pinion 32 mounted on arbour 34 carrying minute hand 36. A wheel 38, meshed with the rotor of clockwork motor 40, is also mounted on arbour 34.

Hour pipe 22 is mounted so as to rotate freely on arbour 34 in a conventional manner.

Disc 10 has, on its bottom face, a toothed crown 44. Minute wheel set 28 also forms an intermediate wheel set between wheel 24 associated with hour hand 12 and disc 10. For this purpose, Minute wheel set 28 is extended by an arbour 46 having, at its end, a pinion 48 that meshes with toothing 44. The gears are defined so as to have a reduction coefficient of two between wheel 24 and pinion 26. In other words, the gear ratio between toothed crown 44 and pinion 48 is two times greater than the gear ratio between wheel 24 and pinion 26. Thus, disc 10 completes one revolution when hand 12 completes two, which enables the information required to be correctly displayed.

It will be noted that disc 10 is located in a recess of plate 56 and that its top face 14 is visible through an aperture arranged in dial 52. Plate 56 is provided with an aperture adjusted to the dimensions of arbour 46 of Minute wheel set 28. The hub of wheel 30 and pinion 48 position Minute wheel set 28 axially in plate 56.

Other arrangements using the essential features of the present invention can naturally be envisaged by those skilled in the art. The embodiment described in FIG. 2 is distinguished by its simplicity of execution and sparing use of wheel sets. The arrangement of the drive means is relatively simple and allows a compact embodiment. It will be noted that the embodiment of the timepiece according to the invention only generates a small additional cost compared to a basic calibre.

What is claimed is

1. A timepiece including an analogue time display arranged such that the hour hand completes one revolution in twelve hours, wherein it further includes a disc having a visible surface and defining a geometrical axis of rotation identical to the axis of said hour hand, said disc being driven by drive means of the timepiece so as to complete one revolution in twenty-four hours in the same direction as that of said hour hand, said visible surface of said disc visually defining two half-discs positioned relative to said hour hand to indicate AM-PM information or the day-night information relating to the time displayed by said hour hand.

2. The timepiece according to claim 1, wherein the drive means include a Minute wheel set arranged, in addition to driving disc, to drive the hour hand via a gear train.

3. The timepiece according to claim 2, wherein said Minute wheel set further includes a Minute wheel set wheel meshed with a pinion arranged on the arbour of a minute hand which is coaxial to said hour hand.

4. The timepiece according to claim 1, wherein said analogue time display is provided for indicating the local time in a second time zone, different from the first time zone of the user of the timepiece whose time is displayed by a main analogue display.

5. The timepiece according to claim 2, wherein said analogue time display is provided for indicating the local time in a second time zone, different from the first time zone of the user of the timepiece whose time is displayed by a main analogue display.
